(19) United States
(12) Patent Application Publication
(10) Pub. No.: US 2018/0067738 A1
(43) Pub. Date: Mar. 8, 2018

(54) AUTOMATIC DEPLOYMENT OF CONTROL CODE

(71) Applicant: General Electric Company, Schenctady, NY (US)

(72) Inventors: William Borea NOTO, Schenectady, NY (US); Paul O. CAFFREY, Salem, VA (US); David Charles KORIM, Schenectady, NY (US); Minesh Ashok SHAH, Schenectady, NY (US)

(73) Assignee: General Electric Company, Schenectady, NY (US)

(21) Appl. No.: 15/556,014

(22) PCT Filed: Mar. 6, 2015
(86) PCT No.: PCT/US15/19208

§ 371 Date: Sep. 6, 2017

(51) Int. Cl. G06F 9/445; G05B 19/05; H04L 12/24

(52) U.S. Cl. CPC G06F 8/65; H04L 41/082; G05B 19/056; G06F 8/61

(57) ABSTRACT

A system and approaches for automatically deploying control code are provided where a notification of an update to an industrial asset is received and permission to update the asset is granted. A measure of a sensed environmental condition from the asset is received, and a determination is made whether to apply the update to the asset based on the measure of the sensed environmental condition.

### BACKGROUND OF THE INVENTION

### Field of the Invention

The subject matter disclosed herein generally relates to providing updates to industrial assets, and more specifically automatically deploying and updating control code upon environmental conditions being met.

### Brief Description of the Related Art

A variety of approaches have been used to manage and update industrial assets, including the use of manually updating the industrial assets using physical connections and/or components. System integrators and complex system owners must deploy and maintain industrial control systems for their industrial assets. Controls oftentimes include control code, diagnostics code, and operating parameters. These assets may be controlled on a one-by-one basis in which individual assets are configured or managed separately from other assets.

In order to apply updates or upgrades to these control systems, an operator must approve the update and certain environmental conditions must be met. Updates applied when environmental conditions are not met may result in lost production and associated lost revenue. Manually monitoring environmental conditions may be expensive compared to an automated solution.

Additionally, control code and diagnostics code oftentimes remains the same throughout the life of the industrial asset. In the event of a necessary update to an operating parameter of the industrial asset, the asset must be taken offline and the update must be provided to the asset. However, because the controls are coupled together, updates to parametric values and operation of the industrial asset oftentimes requires the transmittal of the unmodified control and diagnostics code in addition to the modified parametric value. These data packages may be large and thus require significant bandwidth and transmittal time.

The above-mentioned problems have resulted in some user dissatisfaction with previous approaches.

### BRIEF DESCRIPTION OF THE INVENTION

The approaches described herein provide for the automated deployment of new control, parameters, and/or diagnostic code to industrial assets at remote locations. A system is installed at the remote location that subscribes or receives updates from a centralized update service having available updates and informs local administrators that updates are available. The system then waits for the approval of the local administrator and for appropriate environmental conditions to occur before installing the update.

In many of these approaches, an enterprise level system publishes the updates and provides interfaces to monitor the update deployment status and potential error conditions. In the event that a remote location has multiple assets to which new controls, parameters, and/or diagnostics may be deployed, the system may select a subset of assets to deploy the updates.

By waiting until the environmental condition is met and subsequently automatically applying the update (after receiving permission from the administrator), system downtime is minimized and optimal update times may be utilized, thus increasing overall system efficiencies. Further, by decoupling the parametric data from the remaining controls and diagnostics data, update transmittal times are significantly reduced due to the smaller package size. The installation time at the industrial asset is also reduced because it is no longer necessary to reinstall the entire control system to the industrial asset. Downtime and installation times are also reduced by the system's ability to automatically designate appropriate industrial assets to update within the industrial system.

So configured, the approaches described herein may be used to reduce or eliminate the need for human interaction when performing updates as well as the need to disrupt the process being controlled. Further, these approaches may provide reduced commissioning and maintenance time and expenses to end users and system developers, and reduce costs over the lifecycle of a given asset and control system. The risks of installing incorrect software are also mitigated by eliminating the number of manual processes occurring, as well as the number of individuals interacting with these manual processes. Costs associated with maintaining and servicing industrial assets deployed globally may also be reduced.

By providing updates to the industrial assets, enhanced integrity and security of the system results as the updates improve the correctness of the potentially complex system deployment while allowing up to date security patches as they become available. These approaches may be scaled to upgrade systems at a fleet level as opposed to a single device level.

In some approaches, an industrial system includes a remote station and a controller that controls at least one industrial asset. The remote station is configured to generate an update to the industrial asset and transmit the update to the industrial site which is configured to grant permission to apply the update and receive a measure of a sensed environmental condition from the industrial asset and determine whether to apply the update to the industrial asset based on the measure of the sensed environmental condition.

In some approaches, the remote station is configured to generate the update for fewer than all of the industrial assets. In these examples, the update may be designated for any number of assets as determined by an operator or the control station. In other examples, the remote station may receive the measure of the sensed environmental condition from the industrial asset and determine whether to apply the update to the asset based on the measure.

In other examples, approaches are described where a notification of an update to an industrial asset is received, and permission is granted to update the industrial asset. A measure of a sensed environmental condition is then received from the industrial asset and a determination is made whether to apply the update to the industrial asset based on the measure of the sensed environmental condition.

In some of these forms, the step of receiving the notification includes receiving the update from a remote computing device. This remote computing device may be located at any location separate from the industrial asset. The received measure of the sensed environmental condition may include information representing an operational state of the industrial asset.

In further approaches, upon determining that the information represents an inactive operational state, the update is applied to the industrial asset. Thus, when it is determined that the asset is in an off or idle state, the update is applied, thus minimizing system downtime. In some of these examples, permission to update the industrial asset is automatically granted. This may occur upon initially configuring the system or at a later time.

In yet other forms, an update is first generated to an industrial asset. The update is then transmitted to a controller configured to at least partially control operation of the industrial asset, whereupon an alert is generated that indicates the availability of the update. After granting permission to apply the update, a measure of a sensed environmental condition is received from the industrial asset. When the measure of the sensed environmental condition meets a threshold value, the update is applied to the industrial asset.

In some of these forms, the step of generating the update is performed by a remote computing device located remotely from the controller. The step of granting permission to apply the update may be performed at the controller and/or it may be performed at the remote computing device. Similarly, the measure of the sensed environmental condition may be received by the controller and/or the remote computing device.

### BRIEF DESCRIPTION OF THE DRAWINGS

For a more complete understanding of the disclosure, reference should be made to the following detailed description and accompanying drawings wherein:

FIG. 1 comprises a flow chart illustrating an exemplary approach for automatically deploying control code according to various embodiments of the present invention;

FIG. 2 comprises a flow chart illustrating an exemplary approach for automatically deploying control code according to various embodiments of the present invention;

FIG. 3 comprises a flow chart further illustrating the approach for automatically deploying control code of FIG. 2 according to various embodiments of the present invention;

FIG. 4 comprises a block diagram illustrating an exemplary approach for automatically deploying control code according to various embodiments of the present invention;

FIG. 5 comprises a block diagram illustrating an exemplary system for automatically deploying control code according to various embodiments of the present invention;

FIG. 6 comprises a call-flow diagram illustrating an exemplary approach for automatically deploying control code according to various embodiments of the present invention;

FIG. 7 comprises an call-flow diagram illustrating an alternate approach for automatically deploying control code according to various embodiments of the present invention; and

FIG. 8 comprises a call-flow diagram illustrating an alternate approach for automatically deploying control code according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

Approaches are provided that overcome the need to take an industrial asset offline to apply upgrades to its control system or systems and to transmit entire control packages when only a portion of the control system is being updated. As such, costs associated with maintaining industrial asset software including controls, parameters, and/or diagnostics are reduced by automating the process by which the software is installed at remote locations. In one aspect, a programmable logic controller is located at any number of remote assets or environments and includes controls logic, diagnostics, logic, and parameters.

It will be appreciated that by “industrial asset” or “asset” and as used herein, it is meant any piece of industrial equipment that has a programmable logic controller or other computational device coupled thereto to drive its operation. Examples of assets include water processing plants, solar panels, aircraft engines, medical devices, wind farms, turbines, and the like. Other examples are possible. By “controls logic” and as used herein, it is meant controls which manage the operation of the asset based on user inputs, parameters, and decision-making logic involving the asset's operation. By “diagnostics logic” and as used herein, it is meant controls that determine the appropriate operational state and analyzes information to produce an output to assist in troubleshooting operation of the asset or equipment. By “parameter” and as used herein, it is meant any variable in the control system that has a set value. Examples of parameters include shut-off points or thresholds for components due to operational conditions such as whether it is experiencing significant vibration, high voltages or high temperatures. Other examples are possible.

By decoupling the diagnostics, because the operation of the asset is not modified, it is not necessary to replace the entire control system. In some examples, the decoupled parameters, controls logic, and/or diagnostic logic may be automatically updated without requiring an environmental condition to be met, that is, without requiring the asset to be shut down. Further, when automatically basing the decision to update the control system on environmental conditions being met, the asset will not be forcefully taken offline, thus avoiding unnecessary and unwanted interruptions. Rather, the update will occur at a time which the asset is not operational.

In one specific example, an asset such as a water processing plant is configured to treat water during normal operation. In the event that the asset requires an update to its controller in the form of control logic, diagnostic logic, and/or parameters, the update is transmitted to the asset, but the asset is not taken offline to perform the update. Rather, the system waits until an environmental condition is met, for example when the water processing plant is not treating water. Upon meeting this condition, the update will be installed on or at the asset. Thus, the asset continues to operate under normal conditions and is only updated at a time in which the asset is not presently operating. Other examples are possible.

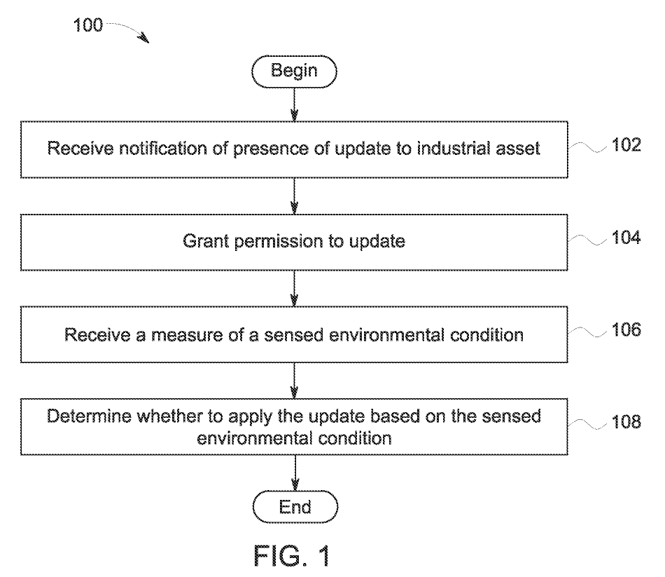

Referring now to FIG. 1, one example of an approach 100 for automatically deploying control code is described. First, at step 102, notification of the presence of an update to an industrial asset is received. This notification may be received by an on-site computing device configured to control the industrial asset, at a remote monitoring location, or any number of alternative devices at any location. At step 104, permission to update the industrial asset is granted. As before, permission may be granted by an on-site computing device, at a remote monitoring location, or any number of alternative devices at any location. Permission to apply the update may also be automatically granted.

At step 106, a measure of a sensed environmental condition is received, and at step 108, it is determined whether to apply the update based on the sensed environmental condition. The measure of the sensed environmental condition may be any value, trigger, identifier, and the like. For example, the sensed environmental condition may be a status of the asset, a temperature reading, a pressure value, or other examples. The determination to apply the update may be preprogrammed by the approach 100 at initial configuration or alternatively, it may be provided upon the step 104 of granting permission to update the asset.

In some examples, the step 102 of receiving the notification includes receiving the update from a remote computing device. The received measure of the sensed environmental condition may include information representing an operational state of the asset. In some examples, the information includes operational state information, such as whether the asset is active, inactive, and/or in a repair or maintenance mode. In these examples, if the asset is determined to be inactive, the update may then be automatically applied. Thus, in some examples, the update may not be applied when the asset is active and/or in a repair or maintenance mode.

In some examples, the asset may be in an active state, but in a lower operational mode. For example, a wind turbine may be active, but rotating at a slow enough speed to be under a threshold value. In these examples, the approach may instruct the asset to enter an inactive state in which the update may be applied. Alternatively, in some examples, the update may be applied while the asset is in the active lower operational mode.

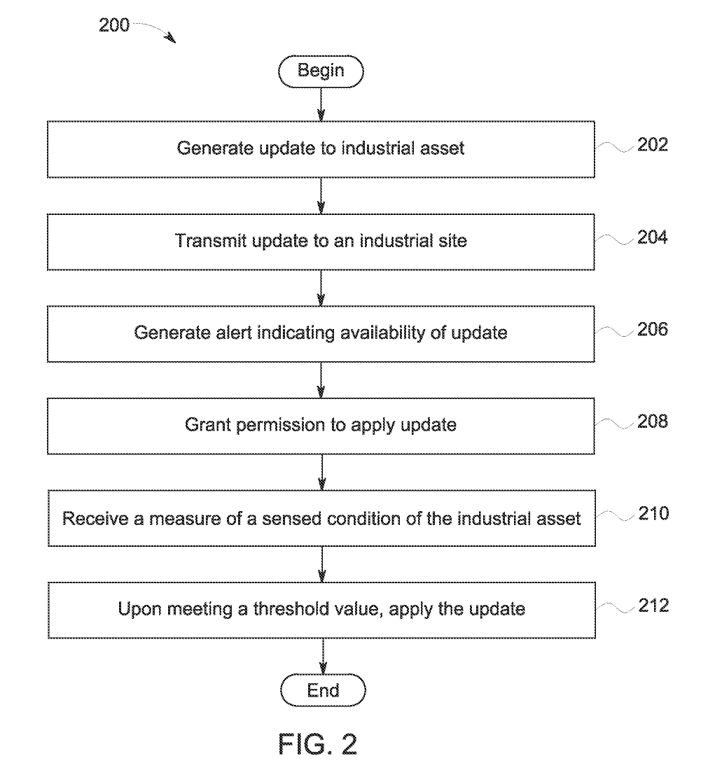

Referring now to FIG. 2, an alternate approach 200 for automatically deploying control code is described. First, at step 202, an update to an industrial asset is generated. At step 204, the update is transmitted to an industrial site. Next, at step 206, an alert is generated indicating the availability of the update, and at step 208, permission to apply the update. At step 210, a measure of a sensed condition of the industrial asset is received, and finally, at step 212, upon meeting a threshold value, the update is applied.

It will be understood that the update may be performed by a remote computing device located remotely from the controller. Further, the step 208 of granting permission to apply the update may be performed at the controller, the remote computing device, or any other location. The step 210 of receiving the measure of the sensed condition may be received by either the controller or the remote computing device.

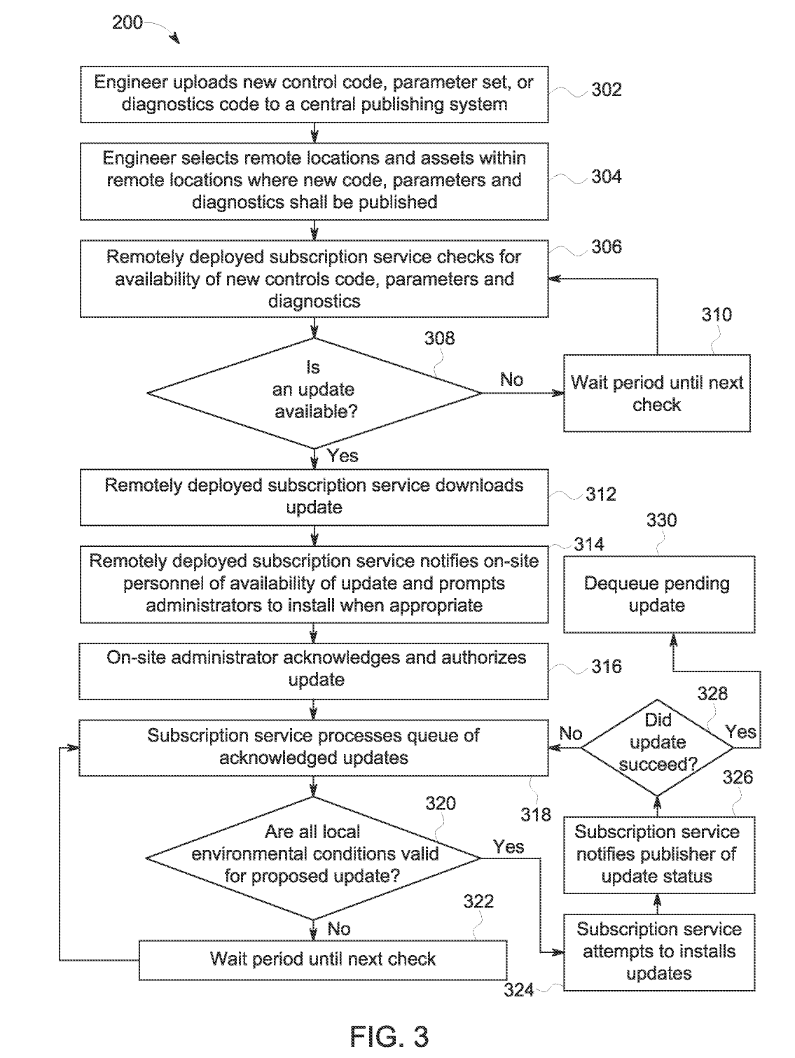

Referring now to FIG. 3, the approach 200 of FIG. 2 is further described. At step 302, a user, engineer, or operator uploads the new instance of the control code, parameter set, or diagnostics code to a central publishing system. At step 304, the operator selects remote locations and/or assets within the remote locations where the new code, parameters, and/or diagnostics are to be published or installed. In other words, any number of assets may be individually selected to be updated should installing the update on particular assets be undesirable.

At step 306, a remotely deployed subscriptions service (RDSS) responsible for installing and monitoring updates checks to see if new updates to control code, parameters, and/or diagnostics are available. At step 308, the approach determines whether an update is available. If there is not an update available, the approach proceeds to step 310 where the RDSS waits a predetermined period until returning to step 306.

If an update is available, the RDSS downloads the update at step 312. At step 314 the RDSS notifies on-site personnel of the availability of the update and prompts them to install the update when appropriate. At step 316, the on-site administrator acknowledges and authorizes the update. At step 318, the RDSS processes the queue of acknowledged updates.

At step 320, the approach determines whether all local environmental conditions are valid for the proposed update. If all of the local environmental conditions are not valid, the approach 200 proceeds to step 322, where the RDSS waits a predetermined period until returning to step 318.

If the local environmental conditions are valid for the proposed update, the approach proceeds to step 324, where the RDSS attempts to install the update. At step 326, the RDSS notifies the engineer or publisher of the status of the update. At step 328, it is determined whether the update succeeded. If the update did not succeed, the approach returns to step 318. If the update did succeed, the approach 200 proceeds to step 330, where the pending update is removed from the queue.

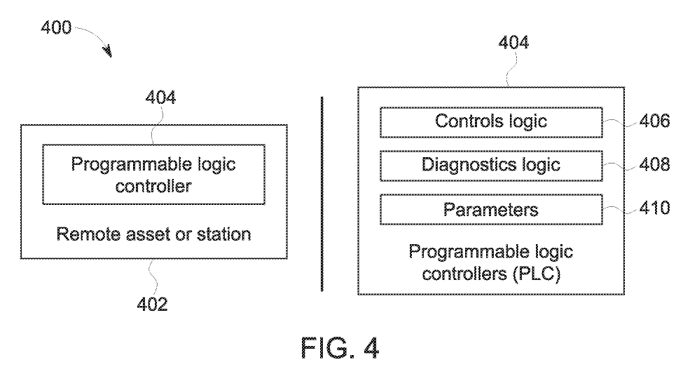

Referring now to FIG. 4, a block diagram illustrating an exemplary system 400 for automatically deploying control code is provided and includes a remote asset or station 402 and a programmable logic controller 404. The programmable logic controller 404 may include controls logic 406, diagnostics logic 408, and parameters 410.

The programmable logic controller controls at least one industrial asset. The remote asset 402 is configured to generate an update to the industrial asset and transmit the asset thereto. The remote asset 402 is further configured to receive permission to apply the update and receive a measure of a sensed environmental condition from the industrial asset. The remote asset 402 then determines whether to apply the update to the industrial asset based on the measure of the sensed environmental condition. The update may be to any or all of the controls logic 406, the diagnostics logic 408, and the parameters 410.

In some approaches, the remote asset 402 is configured to generate the update for fewer than all of the industrial assets controlled by the industrial site. Further, the remote asset 402 may be configured to receive the measure of the sensed environmental condition from the industrial asset and determine whether to apply the update to the industrial asset based on the measure.

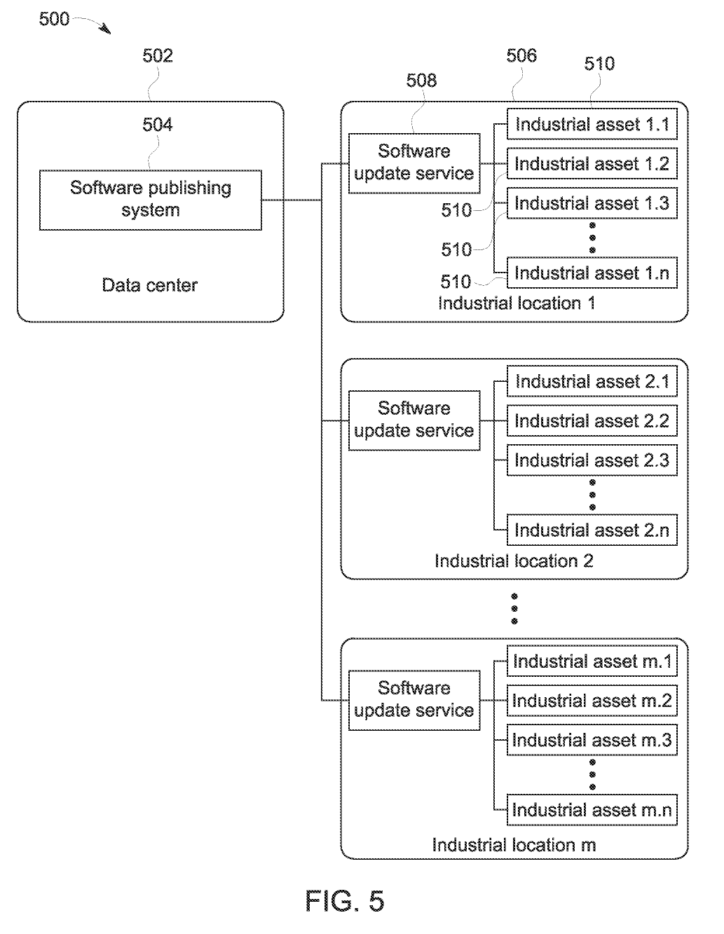

Referring now to FIG. 5, a block diagram illustrating an exemplary system 500 for automatically deploying control code is described. The system 500 includes a data center that includes a software publishing system 504, any number of remote locations 506 that include a software update service 508 and any number of industrial assets 510.

The data center 502 and the remote locations are configured to communicate with each other over any number of communications networks, for example Ethernet, wireless, or any other suitable protocol. The data center 502 and the remote locations 506 may be centrally located, or alternatively, they may be located remote from each other.

The software publishing system 504 may be any software configured to create and/or receive updates to the control system. The software update service 508 may be any system configured to receive data and apply the data to the industrial assets 510. The industrial assets 510 may be located remotely from any or all of the other components such as the data center 502 and the software update service 508.

In operation, the software publishing system 504 generates or receives a previously published update to control code and transmits the update to the software update service 508. The software publishing system 504 may designate particular remote locations 506 and/or particular industrial assets 510 at particular remote locations 506 to be updated. Further, the software publishing system 504 may determine particular environmental conditions that must be satisfied before the updates may be installed. Thus, any number of assets and locations may be updated by the software publishing system 504 designating them. The software update service 508 then waits for the environmental conditions at the industrial asset or assets 510 to be satisfied, and upon determining the environmental condition or conditions are satisfied, the software update service 508 then transmits the update to the industrial assets. 510.

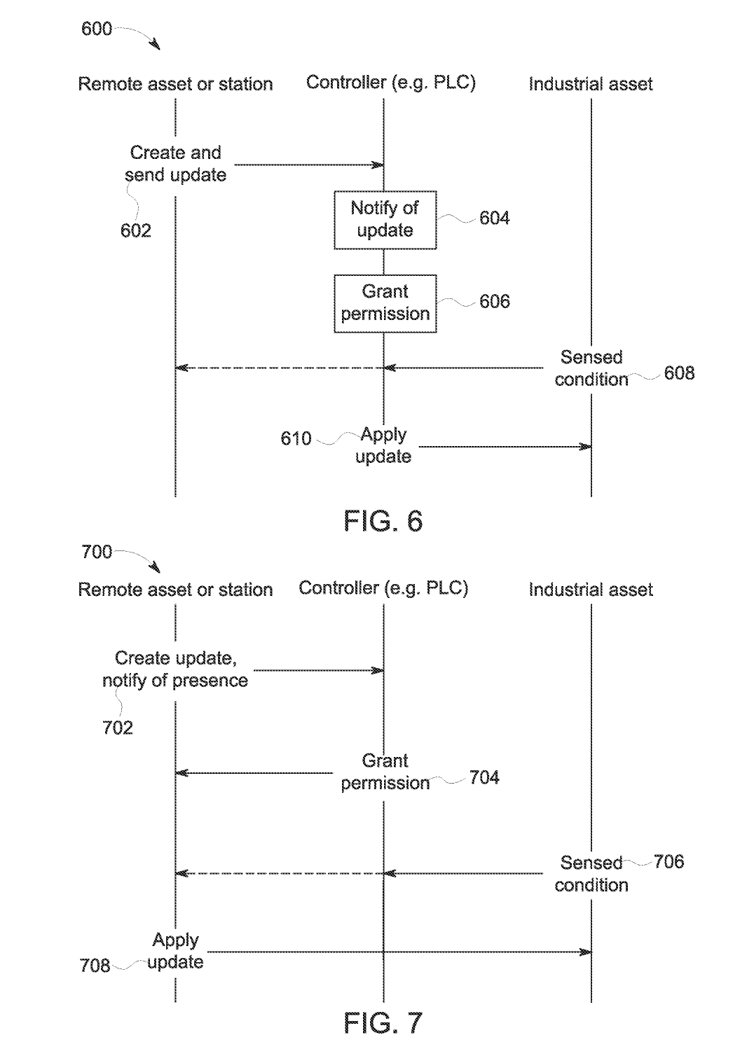

Referring now to FIG. 6, an approach 600 for automatically deploying control code as provided in the preceding figures is described. First, at step 602, a remote asset or station creates and sends an update to the controller. At step 604, the controller (for example, the PLC described with respect to FIG. 4) generates a notification of an update, and at step 606, permission is granted by the controller to install the update. At step 608, the industrial asset transmits to the controller a sensed condition, and upon the sensed condition meeting a threshold value, the controller applies the update at step 610. It will be understood that the step 608 of transmitting the sensed condition may be transmitted to the controller and/or the remote station depending on desired configurations.

As an example, the data center 502 of FIG. 5 may consist of the remote asset or station which in turn includes the software publishing system 504. The data center may be located at a remote facility capable of managing the operation of any number of remote locations. One example of the controller may be the software update service 508 of FIG. 5 which may be disposed at a facility or environment in which the industrial asset is located, such as, for example, a wind farm, a power plant, and the like. Other examples are possible. Each industrial asset may in turn be one component located at the facility, for example, a single wind turbine.

Referring now to FIG. 7, an alternate approach 700 for automatically deploying control code is described. First, at step 702, a remote station creates an update and notifies the controller of its availability. At step 704, the controller (for example, the PLC described with respect to FIG. 4) grants permission to install the update. At step 706, the industrial asset transmits to the controller a sensed condition, and upon the sensed condition meeting a threshold value, the remote station applies the update at step 708. It will be understood that in this approach 700, the step 706 of transmitting the sensed condition may be transmitted to the controller and/or the remote station depending on desired configurations.

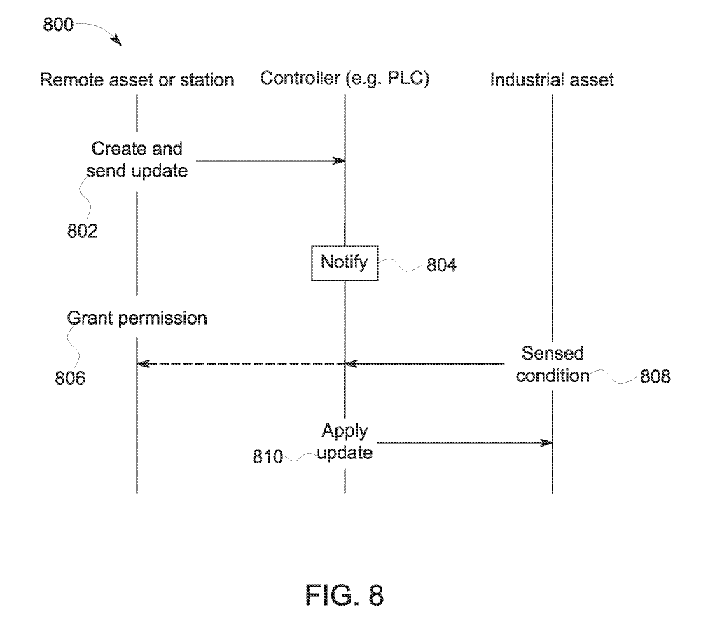

Referring now to FIG. 8, an alternate approach 800 for automatically deploying control code is described. First, at step 802, a remote station creates and sends an update to the controller. At step 804, the controller (for example, the PLC described with respect to FIG. 4) generates a notification of an update, and at step 806, permission is granted by the remote station to install the update. At step 808, the industrial asset transmits to the controller a sensed condition, and upon the sensed condition meeting a threshold value, the controller applies the update at step 810. It will be understood that the step 608 of transmitting the sensed condition may be transmitted to the controller and/or the remote station depending on desired configurations.

It will be understood that the functionality of the components described may be provided on a single, physical chip or on multiple chips (or other components) disposed at multiple locations. The system described herein may be retrofitted on an existing control system without the need for substantial system redesign.

It will be appreciated by those skilled in the art that modifications to the foregoing embodiments may be made in various aspects. Other variations clearly would also work, and are within the scope and spirit of the invention. The present invention is set forth with particularity in the appended claims. It is deemed that the spirit and scope of that invention encompasses such modifications and alterations to the embodiments herein as would be apparent to one of ordinary skill in the art and familiar with the teachings of the present application.

What is claimed is:

1. A method, comprising:
receiving a notification of an update to an industrial asset;
granting permission to update the industrial asset;
receiving a measure of a sensed environmental condition from the industrial asset;
determining whether to apply the update to the industrial asset based on the measure of the sensed environmental condition.

2. The method of claim 1, wherein the step of receiving the notification comprises receiving the update from a remote computing device.

3. The method of claim 1, wherein the received measure of the sensed environmental condition comprises information representing an operational state of the industrial asset.

4. The method of claim 3, further comprising:
upon determining the information represents an inactive operational state, applying the update to the industrial asset.

5. The method of claim 4, wherein permission to update the industrial asset is automatically granted.

6. A method comprising:
generating an update to an industrial asset;
transmitting the update to a controller configured to at least partially control operation of the industrial asset;
generating an alert indicating availability of the update;
granting permission to apply the update;
receiving a measure of a sensed environmental condition from the industrial asset;
upon the measure of the sensed environmental condition meeting a threshold value, applying the update to the industrial asset.

7. The method of claim 6, wherein the step of generating the update is performed by a remote computing device located remotely from the controller.

8. The method of claim 6, wherein the step of granting permission to apply the update is performed at the controller.

9. The method of claim 7, wherein the step of granting permission to apply the update is performed at the remote computing device.

10. The method of claim 6, wherein the measure of the sensed environmental condition is received by the controller.

11. The method of claim 7, wherein the measure of the sensed environmental condition is received by the remote computing device.

12. An industrial system comprising:
a remote station; and
a controller controlling at least one industrial asset;
wherein the remote station is configured to generate an update to the industrial asset and transmit the update to an industrial site, the remote station configured to receive permission to apply the update and receive a measure of a sensed environmental condition from the industrial asset and determine whether to apply the update to the industrial asset based on the measure of the sensed environmental condition.

13. The industrial system of claim 12, wherein the remote station is configured to generate the update for fewer than all of the at least one industrial asset controlled by the industrial site.

14. The industrial system of claim 12, wherein the remote station is configured to receive the measure of the sensed environmental condition from the industrial asset and determine whether to apply the update to the industrial asset based on the measure.
